(19) United States
(12) Patent Application Publication
(10) Pub. No.: US 2009/0136023 A1
(43) Pub. Date: May 28, 2009

(54) Data Encryption Method Using Discrete Fractional Hadamard Transformation

(75) Inventors: Jeng-Shyang Pan, Kaohsiung (TW); Li-Jun Yan, Harbin (CN); Hsiang-Cheh Huang, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: National Kaohsiung University of Applied Sciences, Kaohsiung (TW)

(21) Appl. No.: 11/949,971

(22) Filed: Dec. 4, 2007

(30) Foreign Application Priority Data
Nov. 26, 2007 (TW) 096144690

(51) Int. Cl. H04L 9/28; G06F 17/14

(52) U.S. Cl. 380/28; 708/405

(57) ABSTRACT

A data encryption method using discrete fractional Hadamard transformation includes the steps of: providing a set of data; processing the data with discrete fractional Hadamard transformation to generate at least one Hadamard matrix, the Hadamard matrix having eigen vectors corresponding to eigen values; selecting order parameters from order vectors of the Hadamard matrix; designating the order parameters as a private key in data encryption. In an embodiment, a set of integers is designated to define numerators and denominators of fractions which represent the eigen values of the Hadamard matrix.

### BACKGROUND OF THE INVENTION

1. Field of the Invention

The present invention relates to a data encryption method using discrete fractional Hadamard transformation (DFHaT). More particularly, the present invention relates to the data encryption method encrypting a digital image, a digital message or the like with order vectors of DFHaT.

2. Description of the Related Art

Fractional Fourier Transform (FRFT) is a generalization of Fourier Transform, and outputs of FRFT can achieve the mixed time and frequency components of signals. The discrete fractional Fourier Transform (DFRFT) recently has been widely developed because of the important use of FRFT. It can be found that the DFRFTs with DFT Hermite eigenvectors can provide similar results as continuous case by 1996.

Many orthogonal transforms have been successfully and widely used in signal processing. Some of the orthogonal transforms typically include discrete cosine transform (DCT), discrete Hartley transform (DHT) and Hadamard transform. In the known art fractional versions of DFT and DHT can be successfully used in signal processing. Furthermore, Discrete fractional Hartley transform (DFHaT) has currently developed from the discrete Hartley transform.

Various types of the Hartley transform widely used in image-related processing should be well known to a person skilled in the art, and they have been described in many U.S. patents. For example, the related U.S. patents include: U.S. Pat. No. 7,284,026, entitled “Hadamard transformation method and device;” U.S. Pat. No. 7,188,132, entitled “Hadamard transformation method and apparatus;” U.S. Pat. No. 6,009,211, entitled “Hadamard transform coefficient predictor;” U.S. Pat. No. 5,970,172, entitled “Hadamard transform coding/decoding device for image signals;” U.S. Pat. No. 5,905,818, entitled “method of providing a representation of an optical scene by the Walsh-Hadamard transform, and an image sensor implementing the method;” U.S. Pat. No. 5,815,602, entitled “DCT image compression and motion compensation using the hadamard transform;” U.S. Pat. No. 5,805,293, entitled “Hadamard transform coding/decoding method and apparatus for image signals;” U.S. Pat. No. 4,621,337, entitled “transformation circuit for implementing a collapsed Walsh-Hadamard transform;” U.S. Pat. No. 4,549,212, entitled “image processing method using a collapsed Walsh-Hadamard transform;” U.S. Pat. No. 4,210,931, entitled “video player and/or recorder with Hadamard transform.” Each of the above-mentioned U.S. patents is incorporated herein by reference for purposes including, but not limited to, indicating the background of the present invention and illustrating the state of the art.

The discrete Hartley transform may also be used in data encryption or the like. However, there is a need for improving an image encryption method or a data encryption method by using discrete fractional Hadamard transformation. With regard to the problematic aspects naturally occurring during the use of the discrete fractional Hadamard transformation, it cannot provide a better approach to data encryption to reduce the risk of decipherable possibilities.

As is described in greater detail below, the present invention intends to provide a data encryption method using discrete fractional Hadamard transformation. Order parameters employed in data encryption are selected from order vectors of DFHaT, and are applied as a decryption key (e.g. private key). A set of fractions is generated to represent the order parameters of DFHaT in generating the private key in such a way as to mitigate and overcome the above problem.

### SUMMARY OF THE INVENTION

The primary objective of this invention is to provide a data encryption method using discrete fractional Hadamard transformation. Order parameters used in data encryption are selected from order vectors of DFHaT, and are applied as a private key for decryption. Hence, the data encryption method is successful in utilizing the discrete fractional Hadamard transformation.

Another objective of this invention is to provide the data encryption method using discrete fractional Hadamard transformation. A set of fractions is generated to represent the order parameters of DFHaT in generating the private key. Advantageously, this data encryption method can significantly enhance a degree of reliability in data encryption.

The data encryption method in accordance with an aspect of the present invention includes the steps of:

providing a set of data;

processing the data with discrete fractional Hadamard transformation to generate at least one Hadamard matrix, the Hadamard matrix having eigen vectors corresponding to eigen values formed from fractions;

selecting order parameters from order vectors of the Hadamard matrix;

designating the order parameters as a private key in data encryption.

In a separate aspect of the present invention, further including the step of: designating a set of integers to define numerators and denominators of the fractions which represent the eigen values of the Hadamard matrix.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1A is a digital image view showing a 128×128 original image for being encrypted by a data encryption method in accordance with the preferred embodiment of the present invention;

FIG. 1B is a magnitude image view showing an encrypted image processed by the data encryption method in accordance with the preferred embodiment of the present invention while encrypting the original image shown in FIG. 1A;

FIG. 1C is a digital image view showing a decrypted image in data decryption in accordance with the preferred embodiment of the present invention, with using correct order vectors to decrypt the encrypted image as shown in FIG. 1B;

FIG. 1D is a digital image view showing failure of the decrypted image in data decryption in accordance with the preferred embodiment of the present invention, with using incorrect order vectors in decrypting the encrypted image as shown in FIG. 1B; and

FIGS. 2A-2C are three graphical representations illustrating the relationship between mean squared errors of decrypted image and error vectors resulted from the data encryption method in accordance with a preferred embodiment of the present invention, with using different variations in error vectors.

### DETAILED DESCRIPTION OF THE INVENTION

A data encryption method using discrete fractional Hadamard transformation in accordance with a preferred embodiment of the present invention can be applied in transmitting image data, processing signals, communication or other related domains without departing from the spirit and the scope of the invention. The discrete fractional Hadamard transformation used herein is known as generalized discrete fractional Hadamard transformation (GDFHaT).

The data encryption method of the preferred embodiment of the present invention includes the step of: providing a set of data which can be selected from digital signals, digital images, digital videos, digital audio, or the like without departing from the spirit and the scope of the invention. In this preferred embodiment, the data of a digital image is exemplified, but not limited, to implement the data encryption method of the present invention. The image data may be preferably stored in a compact disc, a hard disc or other equivalent devices, or may be provided by any convenient manner if desired.

The data encryption method of the preferred embodiment of the present invention further includes the step of: processing the data with discrete fractional Hadamard transformation to generate at least one Hadamard matrix. A normalized Hadamard matrix of order 2ⁿ, denoted by Hₙ, has eigen values and eigen vectors of Hadamard transform. The eigen vectors of Hₙ, can be normalized in kernel construction and is written as:

zₖ=νₖ/∥νₖ∥₂ (1)

The discrete fractional Hadamard transformation (DFHaT) used herein can be defined by eigen decomposition of Hadamard transform. The eigen decomposition of Hadamard transform can be written in the form of:

$${H}_{n} = {\sum }_{k = 1}^{{2}^{n}} {λ}_{k} {z}_{k} {z}_{k}^{T} = {\sum }_{k = 1}^{{2}^{n}} {e}^{- j k π} {z}_{k} {z}_{k}^{T} \qquad ( 2 )$$

where z^{T} denotes the transpose of z.

The α-order of discrete fractional Hadamard transformation can be written as:

$${H}_{n , α} = V {Λ}^{α} {V}^{T} = {\sum }_{k = 1}^{{2}^{n}} {e}^{- jα k π} {z}_{k} {z}_{k}^{T} \qquad ( 3 )$$

where V is a matrix with the eigenvectors as the column vectors, and Λ is a diagonal matrix with its diagonal entries corresponding to the eigen values for each column eigenvectors νₖ in V.

The DFHaT can be generalized to obtain different fractional powers for the eigen values λₖ=e^{jπk} of the DHaT matrix. The 2ⁿ point 2ⁿ×2ⁿ GDHaT matrix is in the form of:

H_{n, α̅}=V·diag((λ)^{α1},(λ₂)^{α}^{₂},L,(λ₂_{ⁿ})^{α}^{₂}^{ⁿ})·V^{T} (4)

where diag(r₁, r₂, L, r_{N}) is the N×N diagonal matrix whose diagonal elements are r₁, r₂, L, r_{N}.

It is defined that α̅ is a 1×2ⁿ parameter vector consisting of the 2ⁿ independent order parameters of GDFHaT. The 1×2ⁿ parameter vector is in the form of:

α̅=(α₀,α₁,L,α₂_{ⁿ} (5)

To simplify Equation (4), the matrix can be defined as:

Λ ^{α̅}=diag((λ₁)^{α}^{₁},(λ₂)^{α}^{₂},L,(λ₂_{ⁿ})^{α}^{₂}^{ⁿ}) (6)

wherein α̅ is given in Equation (5).

Equation (4) can be, therefore, rewritten as:

H_{n, α̅}=V·Λ ^{α̅·}V^{T}. (7)

Accordingly, 1×2ⁿ eigen vectors of Hadamard matrix is obtained.

It will be understood that a set of fractions is generated to represent the order parameters of DFHaT in generating a private key, as best shown in Equation (5).

In a preferred embodiment, a set of integers is designated to define numerators and denominators of the fractions which represent eigen values of Hadamard matrix.

The data encryption method of the preferred embodiment of the present invention yet further includes the step of: selecting order parameters from order vectors of the Hadamard matrix. The 2D-GDFHaT of 2ⁿ×2^{m} signal P with order vectors ( α̅; β̅) is given by

P_{( α̅, β̅)}=H_{n, α̅·}P·H_{m, β̅} (8)

where H_{n, α̅} and H_{m, β̅} are defined in Equation (7), respectively, and α and β are the order vectors of sizes 1×2ⁿ and 1×2^{m}, respectively.

The data encryption method of the preferred embodiment of the present invention yet further includes the step of: designating the order parameters as the private key in data encryption. A series of the fractions representing eigen values of Hadamard matrix constitutes the private key for data encryption or decryption.

The relationship between the encrypted output image P and the input image R in the encryption process is

P=H_{n, α̅}·R·H_{m, β̅} (9)

Advantageously, the encrypted image P is protected, and can be only decrypted by the private key constructed from the fractions of the eigen values of Hadamard matrix.

In the decryption process, the decrypted image I is

$$\begin{matrix}I = {H}_{n , - \overline{α}} \cdot P \cdot {H}_{m , - \overline{β}} \\ = {H}_{n , - \overline{α}} \cdot {H}_{n , \overline{α}} \cdot R \cdot {H}_{m , \overline{β}} \cdot {H}_{m , - \overline{β}}\end{matrix} \qquad ( 10 )$$

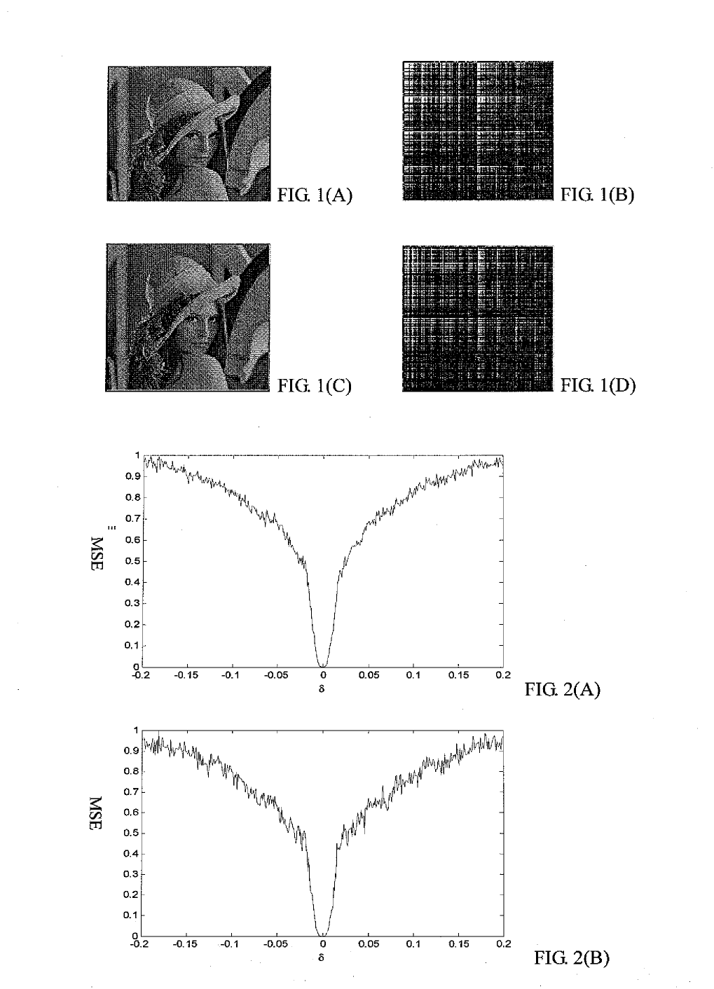

Consequently, the private key selected from the order vectors is successful in decryption of the encoding in the GDFHaT domain. Referring now to FIG. 1A, a 128×128 original image is shown for being encrypted by a data encryption method in accordance with the preferred embodiment of the present invention. The private key with the order vectors ( α̅, β̅) is used to encrypt the original image shown in FIG. 1A.

Turning now to FIG. 1B, an encrypted image processed by the data encryption method in accordance with the preferred embodiment of the present invention is shown. The original image as shown in FIG. 1A is completely encrypted and protected such that an incorrect key cannot decrypt the encrypted image as shown in FIG. 1B.

Turning now to FIG. 1C, a decrypted image in data decryption in accordance with the preferred embodiment of the present invention is shown. In the decryption process the correct private key (i.e. correct order vectors) is used to decrypt the encrypted image as shown in FIG. 1B. It appears that the decrypted image as shown in FIG. 1C is identical with the original image as shown in FIG. 1A.

Turning now to FIG. 1D, failure of the decrypted image in data decryption in accordance with the preferred embodiment of the present invention is shown. In this decryption process, an incorrect key (i.e. incorrect order vectors) is used to decrypt the encrypted image as shown in FIG. 1B.

θ̅= α̅+ δ̅₁, γ̅= β̅+ δ̅ (11)

where δ̅₁ and δ̅₂ are error vectors and independent.

In this experiment, δ=0.001 is input in decryption. It appears that the decryption for the encrypted image as shown in FIG. 1B is completely unsuccessful.

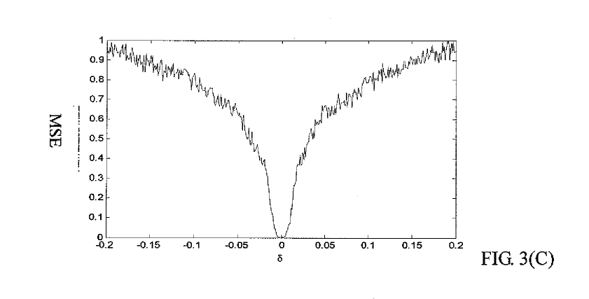

Turning now to FIGS. 2A-2C, three graphical representations of the relationship between mean squared errors of decrypted image and error vectors resulted from the data encryption method in accordance with a preferred embodiment of the present invention are illustrated. The mean squared errors (MSE) used herein indicate normalized failure of the decrypted image resulted from inputting error vectors in data decryption. The normalized mean squared errors (MSE) are distributed over 0 through 1. There are three different types of variations in two error vectors δ₁ and δ₂, as shown in FIGS. 2A-2C. In FIG. 2A, the error vectors δ₁ and δ₂ are distributed over [−δ,δ]; in FIG. 2B, δ₁ is 0 and δ₂ is distributed over [−δ,δ]; in FIG. 2C, tδ₁ is distributed over [−δ,δ] and δ₂ is 0.

As has been discussed above, the data encryption method in accordance with the present invention can provide the private key having a high degree of reliability in data encryption.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A data encryption method, comprising the step of:
providing a set of data;
processing the data with discrete fractional Hadamard transformation to generate at least one Hadamard matrix, the Hadamard matrix having eigen vectors corresponding to eigen values formed from fractions;
selecting order parameters from order vectors of the Hadamard matrix; and
designating the order parameters as a private key in data encryption.

2. The data encryption method as defined in claim 1, further comprising the step of: designating a set of integers to define numerators and denominators of fractions which represent the eigen values of the Hadamard matrix.

3. A data encryption method, comprising:
processing data with discrete fractional Hadamard transformation to generate at least one Hadamard matrix which has eigen vectors corresponding to eigen values formed from fractions, designating order parameters selected from order vectors of the Hadamard matrix as a private key.

4. The data encryption method as defined in claim 2, wherein designating a set of integers to define numerators and denominators of fractions which represent the eigen values of the Hadamard matrix.
